(19) United States
(12) Patent Application Publication
(10) Pub. No.: US 2009/0303074 A1
(43) Pub. Date: Dec. 10, 2009

(54) WIRELESS CONTROL DEVICE AND WIRELESS COMMUNICATION DEVICE USING THE SAME

(75) Inventor: YA-KE LAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/207,599

(22) Filed: Sep. 10, 2008

(30) Foreign Application Priority Data
Jun. 4, 2008 (CN) 200810302018.1

(51) Int. Cl. G05B 19/02

(52) U.S. Cl. 340/825.22

(57) ABSTRACT

A wireless communication device (100) for remotely controlling an electronic device, and for receiving and sending audio signals is disclosed. The wireless communication device includes a microprocessor (10), a touch module (20), a power module (30), an audio module (40) and a wireless transceiver module (50). The touch module includes a touch panel (21) and a touch IC (22) electronically connected to the touch panel. Signals can be entered into the touch IC by touching the touch panel, and be sent to the microprocessor, and then being sent to the electronic device through the wireless transceiver module to remotely control the electronic device. The audio module is configured for inputting an audio signal to the electronic device and outputting an audio signal from the electronic device.

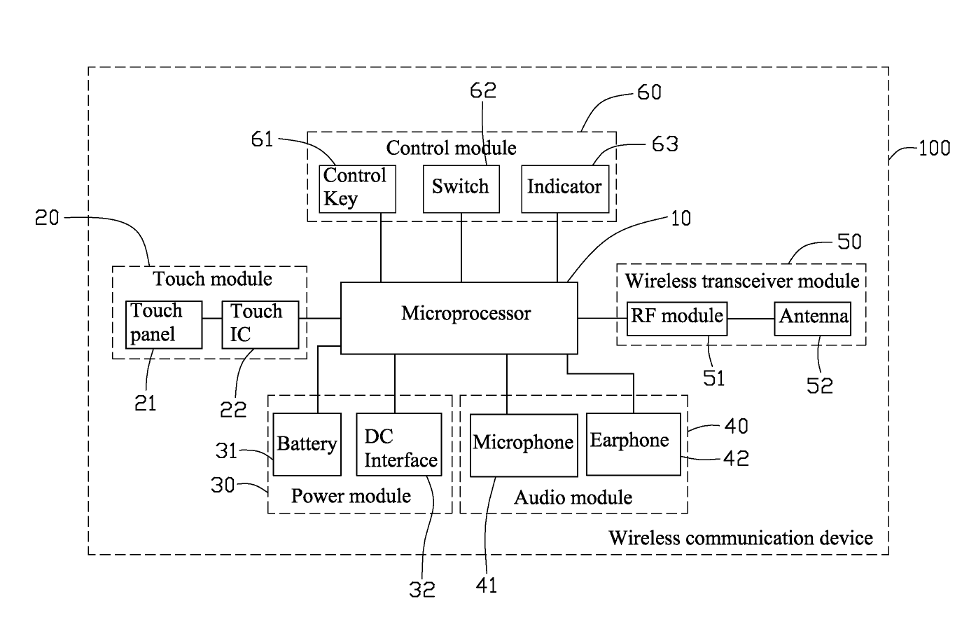

### BACKGROUND OF THE INVENTION

1. Field of the Invention

The present invention generally relates to wireless control devices, and particularly to a wireless control device used for remotely control an electronic device such as a computer, a mobile phone, and so on, and to a wireless communication device using the control device.

2. Description of Related Art

With the development of wireless communication and electronic technologies, electronic devices, such as laptops, mobile phones and personal digital assistants (PDAs), are now in widespread use.

Today, more mobile phones are being produced with GPS (global position system) functions. Mobile phones with projectors are another developing trend. However, mobile phones with these functions cannot be operated remotely. Thus, users are inconvenienced.

Therefore, there is room for improvement within the art.

### BRIEF DESCRIPTION OF THE DRAWINGS

Many aspects of the wireless control device and wireless communication device using the same can be better understood with reference to the following drawings. The drawing is not necessarily drawn to scale, the emphasis instead being placed upon clearly illustrating the principles of the present wireless control device and wireless communication device using the same.

The drawing is a block diagram of a wireless communication device according to an exemplary embodiment of the invention.

### DETAILED DESCRIPTION OF THE EMBODIMENTS

The drawing shows an exemplary embodiment of a wireless communication device 100 for remotely controlling an electronic device such as a mobile phone or computer. The wireless communication device 100 also can be used for receiving and sending audio signals.

The wireless communication device 100 includes a microprocessor 10, a touch module 20, a power module 30, an audio module 40, a wireless transceiver module 50 and a control module 60. The touch module 20, the power module 30, the audio module 40, the wireless transceiver module 50 and the control module 60 are electronically connected to the microprocessor 10. The microprocessor 10 is used for processing signals from the touch module 20, the audio module 40, the wireless transceiver module 50 and control module 60.

The touch module 20 includes a touch panel 21 and a Touch IC (integrated circuit) 22 electronically connected to the touch panel 21. The touch panel 21 is configured externally of the wireless communication device 100. The touch panel 21 can be at least one of a resistance-type touch panel, a capacitance-type touch panel, and a wave-type touch panel. By touching the touch panel 21, signals can be input to activate programs or software in the electronic device. The touch IC 22 is electronically connected to the microprocessor 10. The touch IC 22 receives signals from the touch panel 21 and sends signals to the microprocessor 10.

The power module 30 is configured for supplying voltage for the microprocessor 10, touch module 20, audio module 40, wireless transceiver module 50 and the control module 60. The power module 30 includes a battery 31 and a DC (direct current) interface 32. The power can be supplied by the battery 31 or an external power supply connected to the DC interface 32.

The audio module 40 includes a microphone 41 and an earphone 42. The microphone 41 and the earphone 42 are both electronically connected to the microprocessor 10. The microphone 41 can send audio signals to the microphone 10. The earphone 42 can receive and output audio signals.

The wireless transceiver module 50 includes a RF (radio frequency) module 51 and an antenna 52. The RF module 51 is electronically connected between the microprocessor 50 and the antenna 52. A signal received by the touch IC 22 is processed by the microprocessor 10 and the RF module 51, and then is sent to the electronic device through the antenna 52 to remotely control the electronic device. Also, an audio signal input through the microphone 41 can be sent to the RF module 51 through the microprocessor 10. The RF module 51 process the audio signal and sends it to the electronic device through the antenna 52. Meanwhile, an audio signal can be sent to the antenna 52 from the electronic device, and the RF module 51 processes the audio signal and sends it to the earphone 42 through the microprocessor 10 for output.

The control module 60 includes a control key 61, a switch 62 and an indicator 63. The control key 61, the switch 62 and indicator 63 are electronically connected to the microphone 10. The control key 61 is configured for adjusting the voice volume of the microphone 41 and/or the earphone 42. The switch 62 is configured for activating and deactivating the touch panel 21. Operating the switch 62 can switch the mode of the wireless communication device 100 into touch mode or non-touch mode. In touch mode, the microprocessor 10 sends a signal to the electronic device through the wireless transceiver module 50 to notify the electronic device that it will be operated in touch mode. Then, the electronic device can be remotely operated by operating the touch panel 21. In non-touch mode, the touch panel 21 and the touch IC 22 is deactivated, to avoid an error caused by unexpected touching of the touch panel 21. The indicator 63 includes an indicator light or several indicator lights with different colors for indicating the current mode of the wireless communication device 100.

It should be understood that, the microprocessor 10, the touch module 20, the power module 30, the wireless transceiver module 50 and the control module 60 can form a wireless control device of the electronic device. The wireless control device is used for remotely controlling the electronic device. In addition, the RF module 51 can be a Bluetooth module. The control module 60 can be canceled, and the touch module 20 can always be activated. When the electronic device is in a vehicle, the wireless communication device 100 can be configured in the steering wheel of the vehicle for easy and safe use.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless control device for remotely controlling an electronic device, comprising:
a microprocessor;
a wireless transceiver module electronically connected to the microprocessor;
a touch module electronically connected to the microprocessor, the touch module including a touch panel and a touch IC electronically connected to the touch panel, wherein signals can be entered into the touch IC by touching the touch panel, the signals can be sent to the microprocessor and processed, and then the signals can be sent to the electronic device through the wireless transceiver module to remotely control the electronic device; and
a power module electronically connected to the microprocessor for powering the control device.

2. The wireless control device of claim 1, wherein the wireless transceiver module includes an RF module and an antenna, the RF module being electronically connected between the microprocessor and the antenna, the RF module configured for processing signals from the microprocessor and sending the signals to the electronic device through the antenna.

3. The wireless control device of claim 2, wherein the RF module is a Bluetooth module.

4. The wireless control device of claim 1, further comprising a control module, the control module including a switch electronically connected to the microprocessor, the switch being configured for activating or deactivating the touch panel.

5. The wireless control device of claim 4, wherein the control module further comprises an indicator electronically connected to the microprocessor.

6. A wireless communication device for remotely controlling an electronic device, and for receiving and sending audio signals, the wireless communication device comprising:
a microprocessor;
a wireless transceiver module electronically connected to the microprocessor;
a touch module electronically connected to the microprocessor, the touch module including a touch panel and a touch IC electronically connected to the touch panel, wherein signals can be entered into the touch IC by touching the touch panel, the signals can be sent to the microprocessor and processed, and then the signals can be sent to the electronic device through the wireless transceiver module to remotely control the electronic device;
an audio module electronically connected to the microprocessor, the audio module being configured for inputting an audio signal to the electronic device and outputting an audio signal from the electronic device; and
a power module electronically connected to the microprocessor for powering the wireless communication device.

7. The wireless communication device of claim 6, wherein the wireless transceiver module includes an RF module and a antenna, the RF module being electronically connected between the microprocessor and the antenna, the RF module configured for processing signals from the microprocessor and sending the signals to the electronic device through the antenna.

8. The wireless communication device of claim 7, wherein the RF module is a Bluetooth module.

9. The wireless communication device of claim 6, further comprising a control module, the control module including a switch electronically connected to the microprocessor, the switch being configured for activating or deactivating the touch panel.

10. The wireless communication device of claim 9, wherein the control module further comprises an indicator electronically connected to the microprocessor.

11. The wireless communication device of claim 10, wherein the control module further comprises a control key electronically connected to the microprocessor, the control key being configured for adjusting the voice volume of the audio module.

12. The wireless communication device of claim 6, wherein the audio module includes a microphone and an earphone, an audio signal being input into the microprocessor through the microphone, and the microprocessor sending the audio signal to the electronic device through the wireless transceiver module.

13. The wireless communication device of the claim 12, the wireless transceiver module receives an audio signal from the electronic device and sends the audio signal to the earphone through the microprocessor, the audio signal being output by the earphone.
